(19) United States
(12) Patent Application Publication
(10) Pub. No.: US 2026/0184374 A1
(43) Pub. Date: Jul. 2, 2026

(54) FRONT END MODULE

(71) Applicants: Hyundai Motor Company, Seoul (KR); Kia Corporation, Seoul (KR)

(72) Inventors: Yeong Jae Kim, Hwaseong-si (KR); Joong Hyun Shin, Hwaseong-si (KR); Jung Hwan Noh, Gyeongsan-si (KR); Tae Min Lee, Gyeongsan-si (KR)

(21) Appl. No.: 19/174,211

(22) Filed: Apr. 9, 2025

(30) Foreign Application Priority Data
Dec. 26, 2024 (KR) 10-2024-0196835

(51) Int. Cl. B62D 21/15; B60K 11/04

(52) U.S. Cl. CPC B62D 21/155; B60K 11/04

(57) ABSTRACT

A front end module can include an upper member, wherein the upper member includes a concave recess portion extending downwardly within the upper member, a lower member disposed below the upper member, a side member connecting the upper member to the lower member, a reinforcing member in the recess portion, and a hood latch coupled to the reinforcing member.

### CROSS-REFERENCE TO RELATED APPLICATIONS

This application claims benefit of priority to Korean Patent Application No. 10-2024-0196835 filed on Dec. 26, 2024 in the Korean Intellectual Property Office, the disclosure of which is incorporated herein by reference in its entirety.

### TECHNICAL FIELD

The present disclosure relates to a front end module applied to a vehicle.

### BACKGROUND

The front end module (FEM) of a vehicle is a structure located at the front of a vehicle body. The front end module may absorb impacts when the vehicle collides and may include a radiator, fan, and hood latch securing the hood.

If the hood latch is directly coupled to the front or rear of an upper member of the front end module, a large moment may occur in the upper member when the hood latch receives upward force, which may increase the possibility of damage to a joint. This may cause the upper member itself to deform or the entire front end module to be damaged.

In addition, an existing front end module has to use many additional structural parts or design the upper member to be thick to reinforce the joint rigidity of the hood latch. This design led to an increase in weight, which is disadvantageous for vehicle weight reduction, and there was a problem of reduced productivity and assembly efficiency due to the increased number of parts.

### SUMMARY

An embodiment of the present disclosure can provide a front end module in which joint rigidity of a hood latch can be improved by using a recess portion of an upper member and damage to the front end module and the hood latch can be prevented by effectively dispersing force acting on a vehicle.

The purpose of an embodiment of the present disclosure is not necessarily limited to the purpose mentioned above, and other purposes not mentioned may be clearly understood by those skilled in the art from the description below.

According to an embodiment of the present disclosure, a front end module can include: an upper member; a lower member disposed below the upper member; and a side member connecting the upper member to the lower member. The upper member may be provided with a concave recess portion formed downwardly within the upper member, and a reinforcing member may be provided in the recess portion so that a hood latch can be coupled to the reinforcing member.

An opening may be disposed at a front or rear of the recess portion, and at least a portion of the reinforcing member may face the opening.

The reinforcing member may include: a body portion; a first wing portion disposed on one side of the body portion; and a second wing portion disposed on the other side of the body portion.

The first wing portion and the second wing portion may be inserted into the upper member.

The reinforcing member may include: a first flange portion connecting the first wing portion to the body portion; and a second flange portion connecting the second wing portion to the body portion.

The first flange portion may be inserted into a first sidewall of the recess portion, and the second flange portion may be inserted into a second sidewall of the recess portion.

The body portion and the first wing portion may be arranged to have a step portion.

The body portion may be disposed at an obtuse angle with respect to a bottom surface of the recess portion.

A nut may be welded to a front or rear surface of the body portion, and a first pin hole communicating with a hole of the nut may be disposed in the body portion.

On a front or rear inner wall of the recess portion spaced apart from the body portion, a second pin hole may be disposed to overlap the first pin hole of the body portion in a penetration direction of the first pin hole.

A lower bent portion may be disposed below the body portion, and an edge region of the lower bent portion may be inserted into a bottom surface of the recess portion.

The front end module may include: a hood latch disposed in the recess portion and coupled to the reinforcing member; and a line electrically connected to the hood latch, wherein at least a portion of the line may be disposed in a longitudinal direction of the upper member.

The front end module may include a connector electrically connecting the line to the hood latch.

The recess portion may be disposed in plural, the recess portions may include a first recess portion, and a second recess portion spaced apart from the first recess portion in a longitudinal direction of the upper member, and the reinforcing member may be disposed in each of the first recess portion and the second recess portion.

### BRIEF DESCRIPTION OF THE DRAWINGS

The above and other features and advantages of example embodiments of the present disclosure can be more clearly understood from the following detailed description, taken in conjunction with the accompanying drawings, in which:

FIG. 1 is a perspective view of a front end module according to an embodiment of the present disclosure;

FIG. 2 is a perspective view illustrating a front end module according to an embodiment of the present disclosure from a different angle;

FIG. 3 is a top view of portion A of FIG. 1;

FIG. 4 is an exploded view illustrating portion A of FIG. 1;

FIG. 5 is a cross-sectional view taken along line I-I′ of FIG. 1;

FIG. 6 is an enlarged view of a portion of the upper member of portion A of FIG. 1;

FIG. 7 is a diagram of FIG. 6 taken in a different direction;

FIG. 8 is a perspective view of a reinforcing member, according to an embodiment of the present disclosure;

FIG. 9 is a diagram of FIG. 8 from a different angle;

FIG. 10 is a diagram illustrating a reinforcing member joined to an upper member, according to an embodiment of the present disclosure;

FIG. 11 is a diagram illustrating a structure in which a portion of the reinforcing member in FIG. 10 is inserted into the upper member, according to an embodiment of the present disclosure;

FIG. 12 is a top view of a portion to which a reinforcing member is joined in the upper member, according to an embodiment of the present disclosure;

FIG. 13 is a diagram illustrating a structure in which a portion of the reinforcing member in FIG. 12 is inserted into the upper member, according to an embodiment of the present disclosure;

FIG. 14 is a cross-sectional view taken along line II-II′ of FIG. 10;

FIG. 15 is a diagram illustrating a structure in which a mold is disposed based on a cross-section taken along line III-III′ of FIG. 10;

FIG. 16 is a diagram illustrating a structure in which a mold is disposed based on a cross-section taken along line II-II′ of FIG. 10;

FIG. 17 is a diagram illustrating a front end module according to an embodiment of the present disclosure; and

FIG. 18 is an exploded view of FIG. 17.

### DETAILED DESCRIPTION OF ILLUSTRATIVE EMBODIMENTS

While an embodiment of the present disclosure may be modified in various ways and take on various alternative forms, specific example embodiments are shown in the drawings and described in detail below. However, it can be understood that there is no intent to necessarily limit the present disclosure to the particular forms disclosed, but on the contrary, the present disclosure can cover all modifications, equivalents, and alternatives falling within the spirit and scopes of the present disclosure.

It can be understood that, although the terms “first,” “second,” etc., may be used herein to describe various elements, these elements are not necessarily limited by these terms. These terms can be used merely to distinguish one element from another. For example, a first element could be termed a second element, and a second element could similarly be termed a first element without departing from the scopes of the present disclosure. Terms, such as first and second may be used to describe various components, but these components are not necessarily limited in order, size, location, or importance by terms, such as first and second.

As used herein, the term “and/or” includes any and all combinations of one or more of the associated listed items.

Terms used herein to describe embodiments of the present disclosure are not intended to necessarily limit the scopes of the present disclosure. The articles “a,” and “an” are singular in that they have a single referent, however the use of the singular form in the present document does not necessarily preclude the presence of more than one referent. In other words, elements of the present disclosure referred to in the singular may number one or more, unless the context clearly indicates otherwise.

It can be understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different manner, terms used herein including technical and scientific terms can have same meanings as those which would be understood by those skilled in the art to which the present disclosure pertains. Such terms as defined in generally used dictionaries can be construed to have same meanings as those of the contexts of the related art.

In this specification, vehicles can refer to a variety of vehicles that move transported objects, such as people, animals, or goods, from a starting point to a destination. These vehicles are not necessarily limited to vehicles that run on roads or tracks. Vehicles can include those that use fossil fuels, such as gasoline and petrol, as well as those that use secondary batteries using electricity stored in batteries and those that use future fuels, such as hydrogen.

In the description below, the terms “front,” “rear,” “up/down,” “upward,” “downward,” “above,” “upper,” “top,” “below” “lower” “bottom” “left/right” and the like, can be based on a vehicle or vehicle body.

Hereinafter, example embodiments of the present disclosure will be described with reference to the accompanying drawings.

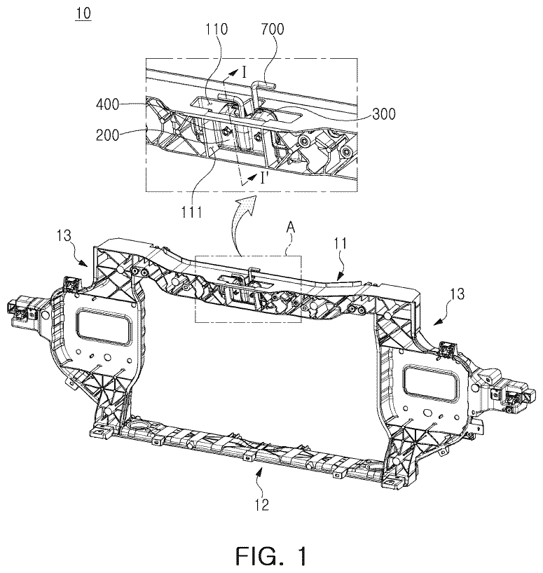

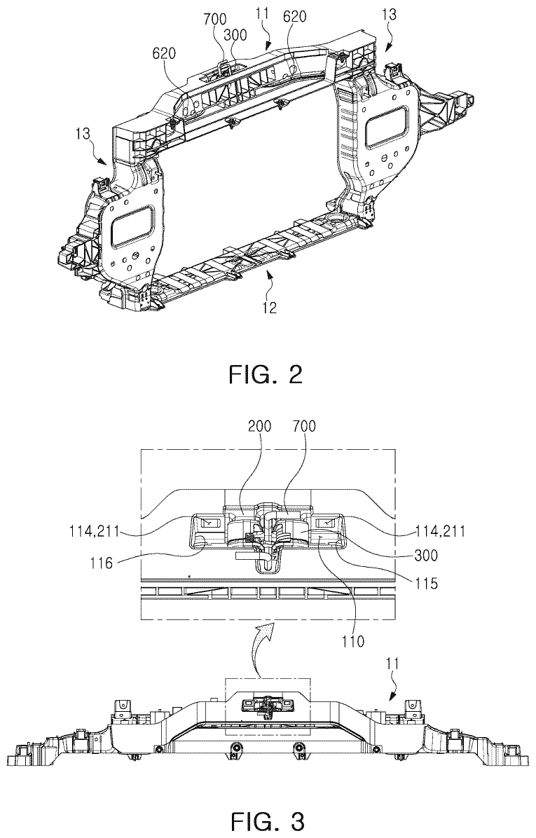

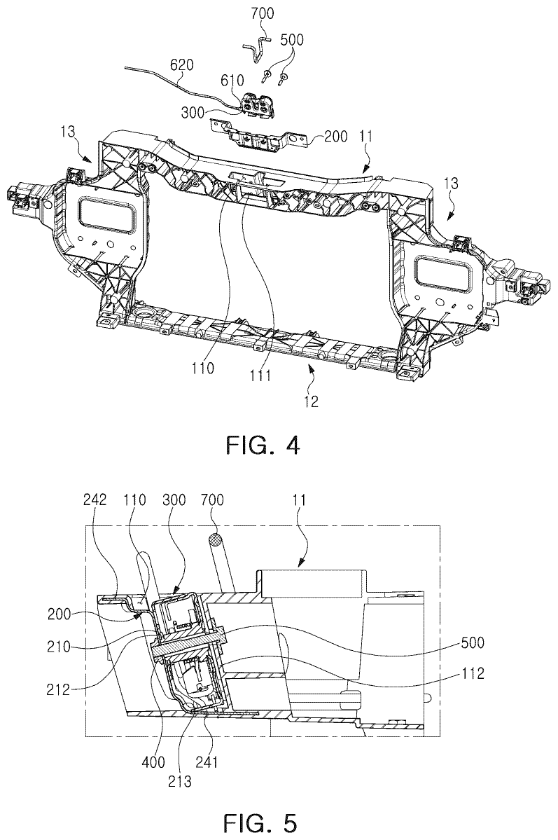

FIG. 1 is a perspective view of a front end module according to an embodiment of the present disclosure. FIG. 2 is a perspective view illustrating a front end module according to an embodiment of the present disclosure from a different angle. FIG. 3 is a top view of portion A of FIG. 1. FIG. 4 is an exploded view illustrating portion A of FIG. 1. FIG. 5 is a cross-sectional view taken along line I-I′ of FIG. 1.

Referring to FIGS. 1 and 2, the front end module 10 according to an embodiment of the present disclosure may include an upper member 11, a lower member 12, and a side member 13.

The upper member 11 may be disposed at an upper portion of the front end module 10. A longitudinal direction of the upper member 11 may be approximately parallel to a width direction of a vehicle body. The lower member 12 may be disposed at a lower portion of the front end module 10. The longitudinal direction of the lower member 12 may be approximately parallel to the width direction of the vehicle body. The side member 13 may be provided in plural. The longitudinal direction of each side member 13 may be approximately parallel to a height direction of the vehicle body. One of side members 13 may connect the upper member 11 to the lower member 12 on one side of the upper member 11. The other of side members 13 may connect the upper member 11 to the lower member 12 on the other side of the upper member 11.

Referring to FIGS. 1 to 4, a recess portion 110 may be disposed in the upper member 11. The recess portion 110 may be formed to be concave from an upper side to a lower side of the upper member 11. An opening 111 may be disposed on an inner front side of the recess portion 110. The opening 111 may be formed to penetrate through a portion of the upper member 11 from the rear to the front of the front end module 10. However, although the opening 111 is described as being disposed at the inner front side of the recess portion 110 according to an example embodiment illustrated in the drawing, the opening 111 may be disposed at the inner rear of the recess portion 110. Accordingly, in a case in which the opening 111 is disposed at the inner rear of the recess portion 110, the components arranged at the inner rear of the recess portion 110 in the embodiment illustrated in the drawing may be disposed at the inner front of the recess portion 110.

A reinforcing member 200 and a hood latch 300 may be disposed in the recess portion 110. A plurality of bolts 500 may be arranged in the recess portion 110 to join the hood latch 300 to the reinforcing member 200 by penetrating through the recess portion 110. A connector 610 can be coupled to the hood latch 300 and may be disposed in the recess portion 110, and a line 620 may be electrically connected to the hood latch 300 through the connector 610. A portion of the line 620 may be disposed on the upper member 11 in the longitudinal direction of the upper member 11. The connector 610 may be provided in plural. Each of at least one connector may be disposed on each of opposite sides of the hood latch 300. That is, at least one connector 610 may be disposed and spaced apart from each other in the longitudinal direction of the upper member 11. At least one line 620 may be disposed, and at least one line 620 may be coupled to the at least one connector 610, respectively. At least a portion of a hood striker 700 mechanically coupled to the hood latch 300 may be disposed in the recess portion 110 in some cases.

Referring to FIG. 5, the reinforcing member 200 can be disposed in the recess portion 110 and coupled to the upper member 11, and the hood latch 300 can be disposed to face the reinforcing member 200 in the recess portion 110. The bolt 500 can penetrate a rear inner wall 112 of the recess portion 110, the hood latch 300, and the reinforcing member 200 and can be screw-coupled to a nut 400 welded to a front surface 212 of a body portion 210 of the reinforcing member 200 to secure the hood latch 300 to the upper member 11. However, the nut 400 may also be welded to a rear surface 213 of the body portion 210.

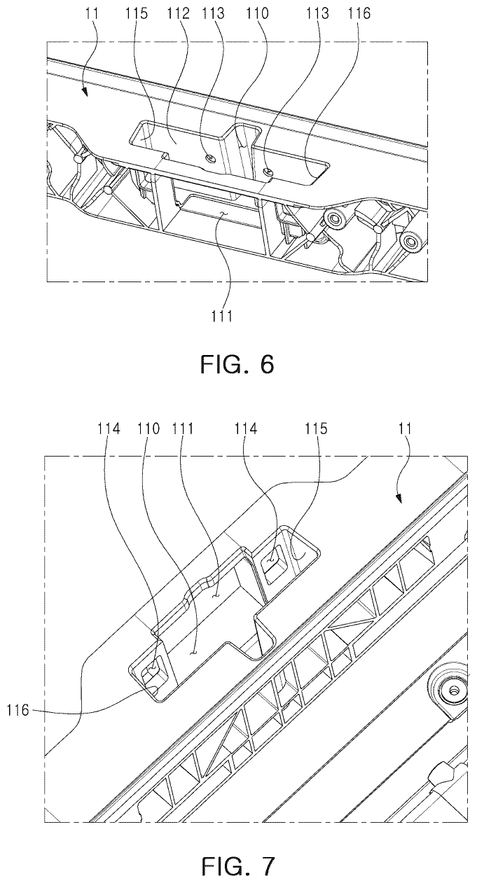

FIG. 6 is an enlarged view of a portion of the upper member of portion A in FIG. 1. FIG. 7 is a view of FIG. 6 taken in a different direction. Referring to FIGS. 6 and 7, the longitudinal direction of the recess portion 110 may be approximately parallel to the longitudinal direction of the upper member 11. The aforementioned opening 111 may be disposed in the front of the recess portion 110. A pin hole may be disposed in the rear inner wall 112 of the recess portion 110. A pin hole to be described below may be disposed in the reinforcing member 200. Therefore, for convenience of description, the pin hole disposed in the reinforcing member 200 may be referred to as a first pin hole 201, and the pin hole disposed in the rear inner wall 112 of the recess portion 110 may be referred to as a second pin hole 113.

The second pin hole 113 may be disposed to penetrate the rear inner wall 112 of the recess portion 110. The second pin hole 113 may be disposed in plural. The pin hole 113, which is at least one pin hole, may be disposed to be spaced apart from others thereof in the longitudinal direction of the upper member 11.

The aforementioned opening 111 may be disposed in front of the recess portion 110. First square holes 114 may be disposed on one side and the other side of the opening 111, respectively. The opening 111 can be covered by the body portion 210 of the reinforcing member 200 to be described below, but the first square holes 114 arranged on one side and the other side of the opening 111 may be disposed to face a second square hole 211 disposed on the reinforcing member 200.

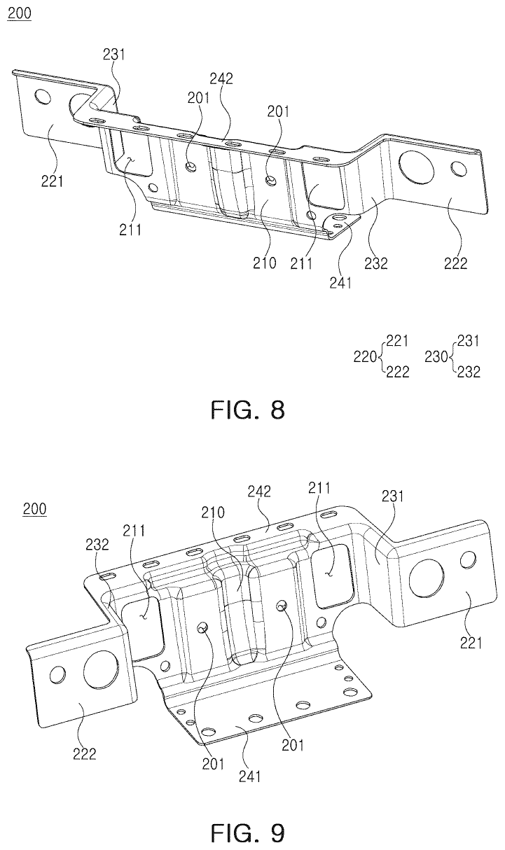

FIG. 8 is a perspective view illustrating the reinforcing member, according to an embodiment of the present disclosure. FIG. 9 illustrates FIG. 8 from a different angle. The structure of the reinforcing member 200 will be described with reference to FIGS. 8 and 9.

The reinforcing member 200 may include the body portion 210, a wing portion 220, a flange portion 230 connecting the body portion 210 to the wing portion 220, a lower bent portion 241 disposed below the body portion 210, and an upper bent portion 242 disposed above the body portion 210.

The first pin hole 201 may be disposed in the body portion 210. The pin hole 201 may be disposed in plural. At least one first pin hole 201 may be disposed to be spaced apart in the longitudinal direction of the upper member 11. The bolt 500 described above may penetrate through the first pin hole 201.

The second square hole 211 may be disposed in the body portion 210. The second square hole 211 may be disposed in plural in the body portion 210, and the plurality of second square holes 211 may be arranged spaced apart from each other in the longitudinal direction of the upper member 11. The second square hole 211 disposed in the body portion 210 may directly face the first square hole 114 disposed in front of the recess portion 110 as described above.

The flange portion 230 may be disposed on one side and the other side of the body portion 210. The flange portion 230 may be bent from one side and the other side of the body portion 210. When the flange portion 230 disposed on one side of the body portion 210 is referred to as a first flange portion 231 and the flange portion 230 arranged on the other side of the body portion 210 is referred to as a second flange portion 232, the first flange portion 231 and the second flange portion 232 may be arranged in a substantially parallel direction.

The wing portion 220 may be disposed on one side and the other side of the body portion 210. The wing portion 220 may be connected to the body portion 210 through the flange portion 230. The wing portion 220 may be bent from the flange portion 230. The body portion 210 and the wing portion 220 may be arranged with a step through the flange portion 230.

The wing portion 220 disposed on one side of the body portion 210 may be referred to as a first wing portion 221, and the wing portion 220 disposed on the other side of the body portion 210 may be referred to as a second wing portion 222.

A direction in which the first wing portion 221 is bent from the first flange portion 231 may be opposite to a direction in which the second wing portion 222 is bent from the second flange portion 232. That is, when the reinforcing member 200 is viewed from above, if the first wing portion 221 is bent from the first flange portion 231 counterclockwise, the second wing portion 222 may be bent from the second flange portion 232 clockwise.

The lower bent portion 241 disposed below the body portion 210 and the upper bent portion 242 disposed above the body portion 210 may be bent in opposite directions with respect to the body portion 210. The lower bent portion 241 may be bent rearwardly of the recess portion 110, and the upper bent portion 242 may be bent forwardly of the recess portion 110.

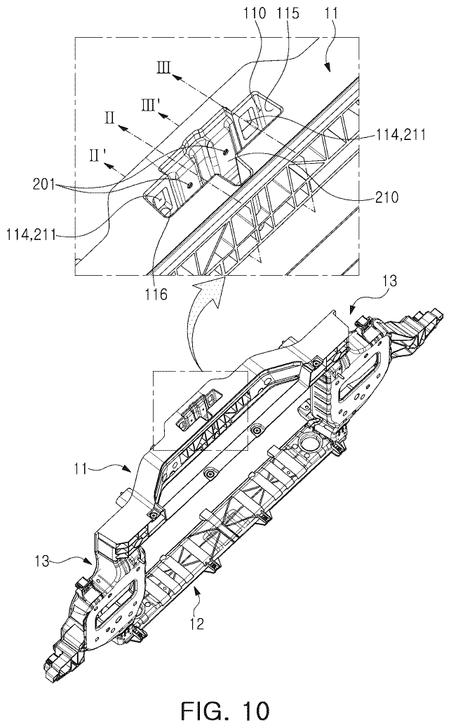

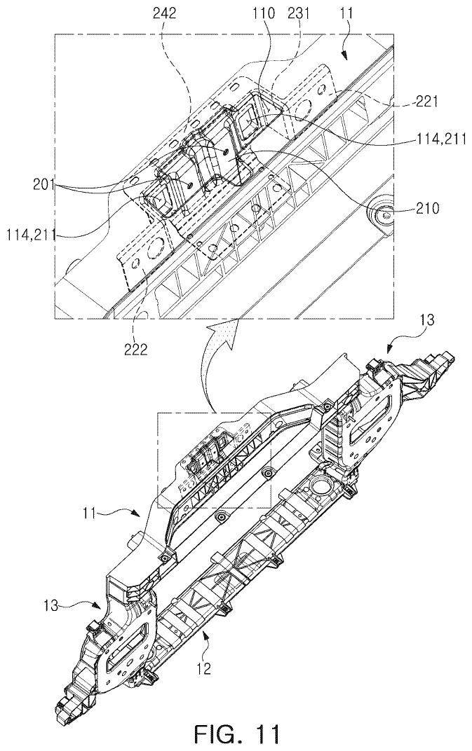

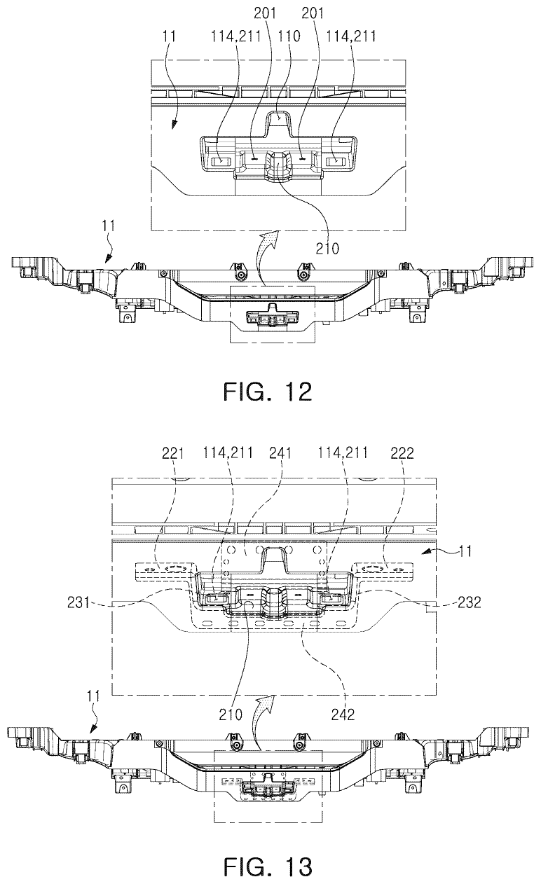

FIG. 10 is a diagram illustrating a reinforcing member joined to an upper member, according to an embodiment of the present disclosure. FIG. 11 is a diagram illustrating a structure in which a portion of the reinforcing member in FIG. 10 is inserted into the upper member, according to an embodiment of the present disclosure. FIG. 12 is a top view of a portion to which a reinforcing member is joined in the upper member, according to an embodiment of the present disclosure. FIG. 13 is a diagram illustrating a structure in which a portion of the reinforcing member in FIG. 12 is inserted into the upper member, according to an embodiment of the present disclosure. A structure in which the upper member and the reinforcing member can be joined will be described with reference to FIGS. 10 to 13.

A portion of the body portion 210 of the reinforcing member 200 may be disposed within the recess portion 110. When viewed from above the recess portion 110, a portion of the body portion 210 may be observed.

A flange portion 230 of the reinforcing member 200 may be inserted into the upper member 11. The first flange portion 231 may be inserted into one of the sidewalls of the recess portion 110, a first sidewall 115, and the second flange portion 232 may be inserted into the other sidewall of the recess portion 110, a second sidewall 116. The first flange portion 231 may be inserted approximately parallel to the first sidewall 115, and the second flange portion 232 may be inserted approximately parallel to the second sidewall 116.

The wing portion 220 may be inserted into the upper member 11. The first wing portion 221 may be inserted in the longitudinal direction of the upper member 11 from the first sidewall 115. The second wing portion 222 may be inserted in the longitudinal direction of the upper member 11 from the second sidewall 116. The first wing portion 221 and the second wing portion 222 may be inserted in the upper member 11 toward the opposite sides. The first wing portion 221 and the second wing portion 222 may be inserted approximately in parallel.

The lower bent portion 241 of the reinforcing member 200 may be disposed on the bottom of the recess portion 110. As seen in FIGS. 11 and 12, the lower bent portion 241 may be exposed through the recess portion 110. However, the edge region, a portion of the lower bent portion 241, may be inserted on the bottom of the recess portion 110.

The upper bent portion 242 of the reinforcing member 200 may be inserted into the upper member 11 at the front of the recess portion 110. When viewed from above the recess portion 110, a portion of the upper bent portion 242 may be exposed to the outside of the upper member 11. An edge region, another portion of the upper bent portion 242, may be inserted into the upper member 11.

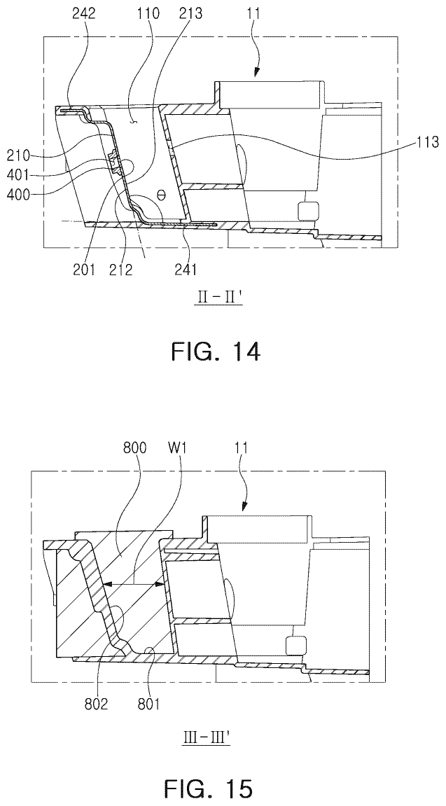

FIG. 14 is a cross-sectional view taken along line II-II′ of FIG. 10. The nut 400 described above may be attached to the front surface 212 of the body portion 210 by welding. The rear surface 213 of the body portion 210 may be disposed to face the inside of the recess portion 110. The body portion 210 may be disposed at an obtuse angle with respect to the bottom of the recess portion 110. The rear surface of the body portion 210 may be disposed at an obtuse angle with respect to the bottom of the recess portion 110.

The nut hole 401 may be disposed to face the first pin hole 201 of the body portion 210. That is, a penetration direction of the nut hole 401 and a penetration direction of the first pin hole 201 may be identical. The second pin hole 113 disposed on the rear inner wall 112 of the recess portion 110 may be disposed to face the nut hole 401 and the first pin hole 201. That is, a penetration direction of the second pin hole 113 may be identical with the penetration directions of the nut hole 401 and the first pin hole 201.

In a front end module 10 according to an embodiment of the present disclosure, the recess portion 110 may be disposed above the upper member 11, a portion of the reinforcing member 200 being inserted into the inside of the recess portion 110, and the hood latch 300 disposed in the recess portion 110 may be coupled to the reinforcing member 200. The hood striker 700 may be fastened to the hood latch 300, and upward force may act on the hood latch 300 by the hood striker 700. Because the hood latch 300 can be disposed in the recess portion 110 of the upper member 11, a moment acting on the upper member 11 by the upward force may be reduced compared to a case in which the hood latch 300 is coupled to the front or rear of the upper member 11. Accordingly, damage to the joint between the upper member and the hood latch by the upward force of the hood striker may be prevented, and further, damage to the upper member and the front end module may also be prevented.

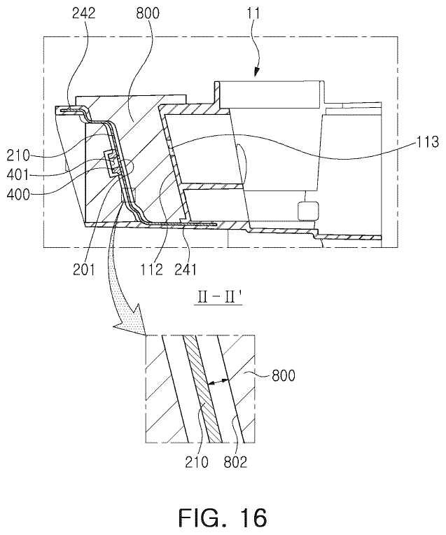

FIG. 15 is a diagram illustrating a structure in which a mold can be disposed based on a cross-section taken along line III-III′ of FIG. 10. FIG. 16 is a diagram illustrating a structure in which a mold can be disposed based on a cross-section taken along line II-II′ of FIG. 10.

Referring to FIG. 15, the mold 800 disposed inside the recess portion 110 may have a width W1 increasing upwardly. That is, a side surface 802 of the mold may be disposed to be inclined based on a bottom surface 801 of the mold. Because the width W1 of the mold 800 increases upwardly, when the mold 800 is moved upwardly from the recess portion 110 and removed, the inner surface of the recess portion 110 and the side surface 802 of the mold 800 may be separated. Therefore, it can be possible to prevent the inner surface of the recess portion 110 from being worn during the process of removing the mold 800.

Referring to FIG. 16, the mold 800 disposed in the recess portion 110 may be disposed apart from the body portion 210 of the reinforcing member 200. The body portion 210 of the reinforcing member 200 and the rear inner wall 112 of the recess portion 100 may be approximately parallel. Therefore, to prevent the body portion 210 from being worn during the process of removing the mold 800, a resin may be injected into the mold 800 disposed apart from the body portion 210 to form the upper member 11. At least a portion of the upper bent portion 242 and the lower bent portion 241 may be disposed to be in surface contact with at least a portion of the mold 800. Therefore, the resin may be prevented from invading the surface of the body portion 210.

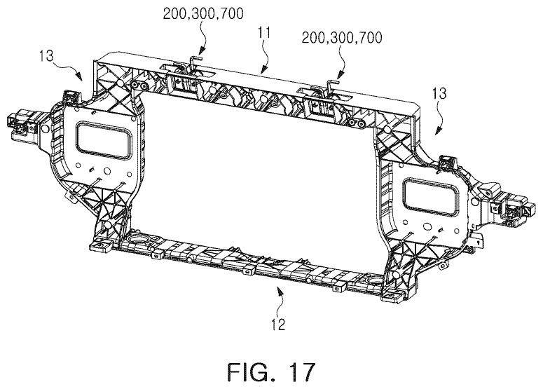

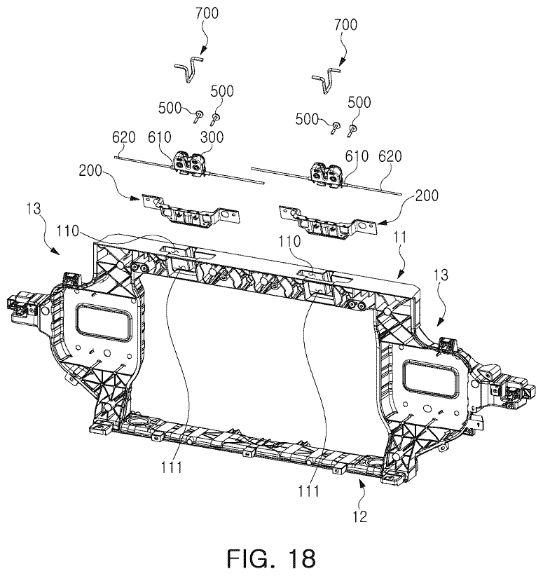

FIG. 17 is a diagram illustrating a front end module according to an embodiment of the present disclosure. FIG. 18 is an exploded view of FIG. 17. A front end module according to an embodiment of the present disclosure will be described with reference to FIGS. 17 and 18. Hereinafter, a same description as that given regarding FIGS. 1 to 16 above is omitted.

At least one recess portion 110 may be disposed on the upper member 11 of the front end module 10. The at least one recess portion 110 may be disposed to be spaced apart from each other in the longitudinal direction of the upper member 11. One of recess portions 110 may be referred to as a first recess portion, and the other may be referred to as a second recess portion.

The reinforcing member 200 may be disposed on each of the first recess portion and the second recess portion. The reinforcing member 200 disposed in the first recess portion may be referred to as a first reinforcing member, and the reinforcing member 200 disposed in the second recess portion may be referred to as a second reinforcing member.

The hood latch 300 may be disposed in the first recess portion and the second recess portion. The hood latch 300 disposed in the first recess portion may be referred to as a first hood latch, and the hood latch 300 disposed in the second recess portion may be referred to as a second hood latch.

For a front end module 10 according to an embodiment of the present disclosure, two reinforcing members 200 and two hood latches 300 may be arranged spaced apart from each other in the upper member 11 in the longitudinal direction of the upper member 11. That is, according to an embodiment of the present disclosure, because the hood latch 300 can be disposed in the recess portion 110 of the upper member 11, damage to the joint between the upper member 11 and the hood latch 300 may be prevented and two hood strikers 700 may be supported in two locations, thereby fixing the hood more stably through force distribution.

In a front end module according to an embodiment of the present disclosure, damage to the joint between the upper member and the hood latch by upward force of the hood striker may be prevented, and further, damage to the upper member and the front end module may be prevented.

The advantages of the present disclosure are not limited to those described above, and other advantages not mentioned can be clearly recognized by those skilled in the art from the description below.

A number of embodiments have been disclosed herein. It can be understood that various features of the different embodiments can be combined. While example embodiments have been shown and described above, it can be apparent to those skilled in the art that modifications and variations could be made without departing from the scope of the present disclosure as defined by the appended claims.

What is claimed is:

1. A front end module comprising:
an upper member, wherein the upper member includes a concave recess portion extending downwardly within the upper member;
a lower member disposed below the upper member;
a side member connecting the upper member to the lower member;
a reinforcing member in the recess portion; and
a hood latch coupled to the reinforcing member.

2. The front end module of claim 1, wherein an opening in the upper member is disposed at a front or rear of the recess portion, and at least a portion of the reinforcing member faces the opening.

3. The front end module of claim 1, wherein the reinforcing member comprises:
a body portion;
a first wing portion disposed on a first side of the body portion; and
a second wing portion disposed on a second side of the body portion.

4. The front end module of claim 3, wherein the first wing portion and the second wing portion are inserted into the upper member.

5. The front end module of claim 3, wherein the reinforcing member further comprises:
a first flange portion connecting the first wing portion to the body portion; and
a second flange portion connecting the second wing portion to the body portion.

6. The front end module of claim 5, wherein the first flange portion is inserted into a first sidewall of the recess portion, and the second flange portion is inserted into a second sidewall of the recess portion.

7. The front end module of claim 3, wherein the body portion and the first wing portion are arranged to have a step portion.

8. The front end module of claim 3, wherein the body portion is disposed at an obtuse angle with respect to a bottom surface of the recess portion.

9. The front end module of claim 3, wherein a nut is welded to a front or rear surface of the body portion, and wherein a first pin hole communicating with a nut hole of the nut is disposed in the body portion.

10. The front end module of claim 9, wherein, on a front or rear inner wall of the recess portion spaced apart from the body portion, a second pin hole is disposed to overlap the first pin hole of the body portion in a penetration direction of the first pin hole.

11. The front end module of claim 3, wherein a lower bent portion is disposed below the body portion, and wherein an edge region of the lower bent portion is inserted into a bottom surface of the recess portion.

12. The front end module of claim 1, further comprising a line electrically connected to the hood latch, wherein at least part of the line is disposed in a longitudinal direction of the upper member, and wherein at least part of the hood latch is within the recess portion of the upper member.

13. The front end module of claim 12, further comprising a connector electrically connecting the line to the hood latch.

14. The front end module of claim 1, wherein the recess portion is disposed in plural, such that the recess portions include a first recess portion and a second recess portion spaced apart from the first recess portion in a longitudinal direction of the upper member, and
wherein the reinforcing member is disposed in plural in each of the first recess portion and the second recess portion, respectively.

15. A front end module of a vehicle, comprising:
an upper member extending in a width direction of the vehicle, wherein the upper member has a top surface having a concave recess portion extending downwardly therein within the upper member;
a reinforcing member embedded in upper member and within the recess portion; and
a hood latch coupled to the reinforcing member, such that at least most of the hood latch is within the recess portion of the upper member.

16. The front end module of claim 15, wherein the reinforcing member comprises:
a central body portion;
a left wing portion extending from a left side of the central body portion; and
a right wing portion extending from a right side of the central body portion.

17. The front end module of claim 16, wherein the left wing portion and the right wing portion are embedded in the upper member.

18. The front end module of claim 16, wherein the reinforcing member further comprises:
a first flange portion connecting the left wing portion to the central body portion, wherein the first flange portion is embedded in a first sidewall of the recess portion; and
a second flange portion connecting the right wing portion to the central body portion, wherein the second flange portion is embedded in a second sidewall of the recess portion.

19. The front end module of claim 16, wherein the reinforcing member further comprises:
a forward-bent flange portion extending forward from an upper portion of the central body portion, wherein the forward-bent flange portion is embedded in the upper member; and
a rearward-bent flange portion extending rearward from a lower portion of the central body portion, wherein the rearward-bent flange portion is embedded in the upper member.

20. A front end module of a vehicle, comprising:
an upper member extending in a width direction of the vehicle, wherein the upper member has a top surface having a concave recess portion extending downwardly therein within the upper member;
a reinforcing member inserted in upper member and within the concave recess portion, wherein the reinforcing member comprises:
a central body portion,
a left rearward-bent flange portion extending from a left side of the central body portion, wherein the left rearward-bent flange portion is inserted in a left sidewall of the concave recess portion of the upper member,
a right rearward-bent flange portion extending from a right side of the central body portion, wherein the right rearward-bent flange portion is inserted in a right sidewall of the concave recess portion of the upper member,
a left wing portion extending from the left rearward-bent flange portion in the width direction of the vehicle, wherein the left wing portion is inserted in the upper member,
a right wing portion extending from the right rearward-bent flange portion in the width direction of the vehicle, wherein the right wing portion is inserted in the upper member,
a top forward-bent flange portion extending forward from an upper portion of the central body portion, wherein the top forward-bent flange portion is inserted in the upper member, and
a bottom rearward-bent flange portion extending rearward from a lower portion of the central body portion, wherein the bottom rearward-bent flange portion is inserted in the upper member; and
a hood latch coupled to central body portion of the reinforcing member, such that at least most of the hood latch is within the concave recess portion of the upper member.
